(19) United States
(12) Patent Application Publication
(10) Pub. No.: US 2005/0237149 A1
(43) Pub. Date: Oct. 27, 2005

(54) Over-lock for self-storage units

(76) Inventors: Jon Loftin, Arden, NC (US); Robert Toy, Waynesville, NC (US)

Correspondence Address: MICHAEL A. MANN;NEXSEN PRUET, LLC, POST OFFICE DRAWER 2426, COLUMBIA, SC, 29202-2426, US

(21) Appl. No.: 11/095,874

(22) Filed: Mar. 31, 2005

Related U.S. Application Data
(60) Provisional application No. 60/564,839, filed on Apr. 23, 2004.

(51) Int. Cl. G06F 7/04

(52) U.S. Cl. 340/5.42; 340/5.5; 340/5.31; 340/5.73

(57) ABSTRACT

The present invention is an electronically controlled self-storage over-lock system that uses distributed processing to allow management to automatically over-lock tenants' units when their accounts become delinquent or when storage units are not rented. Once the self-storage unit door is locked by the over-lock system, tenants cannot access their units their accounts are brought current. Preferably, the over-lock, when in the locked position, prevents movement of the self-storage unit door hasp.

### CROSS REFERENCE TO RELATED PATENTS

The priority benefit of U.S. provisional patent application Ser. No. 60/564,839, filed Apr. 23, 2004, is claimed.

### BACKGROUND OF THE INVENTION

The present invention relates generally to electronic security systems and to electronic over-lock systems for self-storage units in particular.

In the U.S., a burglary currently occurs every 13 seconds. Accordingly, security systems have gained popularity for homeowners and businesses alike. For businesses that lease spaces, a security system is a necessity to compete in the marketplace. Whether it is the lease of apartments, office space, industrial space or self-storage facilities, the ability to attract new customers is greatly dependent upon a reliable security system to protect the tenants' valuable assets.

For self-storage facilities a reliable security system is important, not only to attract new tenants, but also to retain existing tenants. The term self-storage facility describes one or more freestanding buildings, each having a plurality of individual storage units that are typically rented on a monthly basis. In many of these facilities, tenants are responsible for the security of the units they have rented. Accordingly the tenant will put a padlock on the door to the unit to prevent theft.

If a tenant becomes delinquent in the payment of rent, the facility manager is required to place a second lock, or “over-lock” on each unit. This over-lock is used to keep the tenant from accessing the unit until the past due rent is paid. There is thus an increased need for decreasing the manpower associated with the application and removal of over-locks and a desire to automate the process. For example, if a typical self-storage facility consists of five hundred units and during any month, there are 15% of the tenants in arrears, the manager of the self-storage facility must place over-locks on the seventy-five units. These over-locks must also be removed when the tenant brings the account current. Applying and removing over-locks is time-consuming and costly because it includes the manager's time to over-lock the unit and unlock the unit along with the costs associated with the over-locks themselves.

There is also a desire to automate the payment process and allow the customer to pay rent via a remote process. If the customer decides to make a rent payment when the office is closed, perhaps via a web payment or an automated payment machine. If the manager has over-locked the self-storage unit, then the customer cannot gain access to their unit immediately after making the payment. The delay between payment and removal of the over-lock is aggravating to tenants who may then demand immediate attention.

Many self-storage facilities will also place over-locks on vacant units to prevent these units from being used by non-paying customers. This creates a similar problem for the self-storage owner. The owner must maintain an adequate supply of over-locks for vacant units and managers must be available to remove the over-locks for new tenants when they rent a self-storage unit. Moreover, if a self-storage owner wants to rent a self-storage unit via a remote process, the customer does not have access to the self-storage unit until the vacant unit over-lock has been removed.

However, in view of the above, there still remains a need for an electronically-controlled self-storage system that provides facility managers and owners with capabilities that are not possible with the conventional methods.

### SUMMARY OF THE INVENTION

According to its major aspects and briefly described, the present invention is an electronically controlled self-storage over-lock system. Although the system will be described with respect to its application in self-storage facilities, it is clear that the system could be used anywhere an over-lock system is required, such as hotel rooms, apartment buildings, and storage containers and lockers, if permitted by law. Each unit in the facility is preferably equipped with a locking device that is mounted on the inside of the door that can be activated to prevent access to the unit. The locking device controls the movement of the door hasp, which is mounted to the door, and does so preferably electronically, remotely and wirelessly. If the locking device is in the locked position, then the hasp cannot be moved and, accordingly, the door will not open. If the locking device is in the unlocked position, then the hasp can be moved and the door can be opened.

An administrator manages the electronically controlled over-lock system for use in connection with a self-storage facility. The system comprises: a plurality of self-storage units, each having an electronically activated over-lock; at least one input device (e.g., a card reader, keypad, proximity reader, biometric, display and/or touch screen, etc.) for allowing authorized users, namely tenants and prospective tenants, to communicate with the system; at least one over-lock control unit which is in communication with each electronically-activated over-lock; a computer controlled by the system administrator for maintaining a database of authorized users and the over-lock information for each self-storage unit; a system control device in communication with at least one over-lock control unit and with the computer.

The authorized user may access the system to verify that the over-lock has been activated, and then make a payment using the input device to deactivate the over-lock. Once the payment is received, the administrator may cause the computer to enter that fact into the database and to signal the system control device to switch the status of the over-lock from activated to deactivated. The system control device generates a signal to the over-lock control unit for that particular tenant's storage unit. The over-lock control unit deactivates the over-lock, thereby permitting the tenant to move the hasp on the door of the storage unit and open the storage unit door.

A major advantage of the present invention is that the electronically activated over-lock system will reduce the labor requirements for managing a self-storage facility. This advantage derives from the fact that the over-locks can be switched between activated and deactivated conditions without going to each storage unit and manually performing the over-lock process. The system will automatically lock or unlock the over-locked based on the status of the unit and the status of the customer.

Another major advantage of the present invention is that the self-storage system is able to rent storage units to new tenants and to accept payments from delinquent tenants, and then provide access to storage units at the same time. The electronically activated over-lock will automatically lock or unlock the over-locks based on the status of the unit and the status of the customer without onsite personal.

These and other features and their advantages will be apparent to those skilled in the art from a careful reading of the Detailed Description of Preferred Embodiments, accompanied by the following drawings.

### BRIEF DESCRIPTION OF THE DRAWINGS

In the drawings,

FIG. 1 is a schematic overview of the electronically activated over-lock system according to the preferred embodiment of the present invention.

FIG. 2 is a schematic overview of the electronically activated over-lock system installed on a self-storage unit, according to the preferred embodiment of the present invention.

FIG. 3 is a detailed schematic of the electronically activated over-lock system, according to the preferred embodiment of the present invention.

FIG. 4 is a detailed drawing of the door lock mechanism, according to the preferred embodiment of the present invention.

### DESCRIPTION OF THE INVENTION

The present invention is an over-lock security system. Although the system will be described with respect to its application in self-storage facilities, it is clear that the system could be used anywhere an over-lock system is useful.

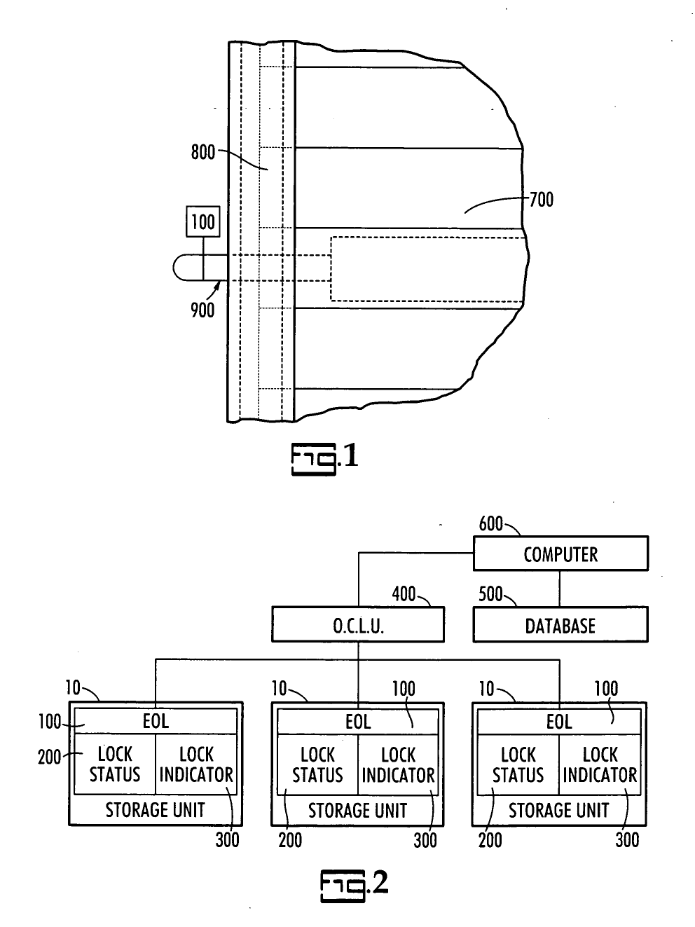

Referring to FIGS. 1 and 2, each self-storage unit 10 is equipped with an over-lock 100 that is preferably mounted on the inside of self-storage unit 10, as seen best in FIG. 2, but, using a wireless connection, over-lock 100 may be mounted on the outside of unit door 700. Each over-lock 100 can have optional equipment including a lock status indicator 200 and an over-lock indicator 300. Each over-lock 100 can be switched remotely and wirelessly via an over-lock control unit 400 between opened (unlocked) or closed (locked) positions, based on the current status of the unit and customer, which status is available to a controller 600 having access to a computer database 500. Communication between the over-lock 100 and the over-lock control unit 400 can be accomplished via wiring or wireless medium with wireless communication preferred. If a person attempts to forcibly open self-storage unit 10 and over-lock 100 contains lock status indicator 200, then a signal is generated by indicator 200 indicating that a forcible entry has been made. Over-lock indicator 300 displays the current status of unit 10. Specifically, it may contain a panel that employs light emitting diodes (LEDs) to indicate that door 700 to unit 10 is open, closed, locked or unlocked.

As best seen in FIG. 2, there is shown a schematic overview of the over-lock system installed in self-storage unit 10. The over-lock device 100 can be mounted on the inside of the self-storage unit. The door hasp 900 is mounted on a self-storage door 700.

The door hasp 900 is manufactured to allow for external padlocks to be placed on the exterior of the door. When the door hasp 900 is in the closed position, it will extend through doorframe 800 and through over-lock 100. Over-lock 100, based on the signal from over-lock control unit 400, will unlock or lock door hasp 900 by allowing or not allowing it to be retracted through the door frame 800, respectively. It is apparent that other methods can be used by over-lock 100 for securing the position of door hasp 900, such as using a pin to extend through a hole in door hasp 900.

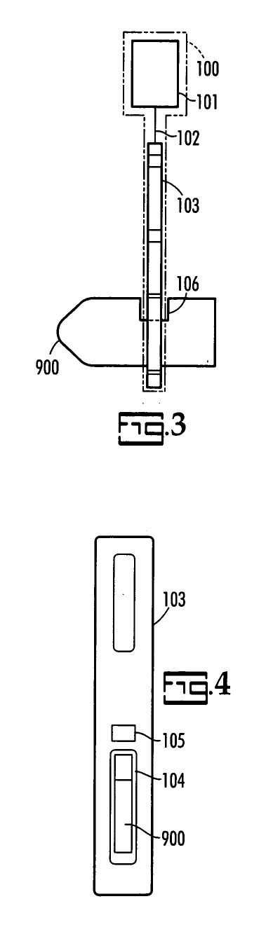

Referring to FIG. 3, there is shown a schematic of over-lock 100. It consists of an actuator 101, which could be a motor or solenoid, connected to a linkage 102. Linkage 102 is connected to a door hasp lock mechanism 103. Door hasp lock mechanism 103 has a slot 104 dimensioned to allow door hasp 900 to pass through. Hasp 900 has a notch 106 formed therein and aligned with door hasp lock mechanism 103. When over-lock 100 is in the closed or locked position, door hasp lock mechanism 103 is lowered into notch 106 so that door hasp 900 cannot be removed, and thus prevent the opening of door 700. When over-lock 100 is in the open or unlocked position, door hasp lock mechanism 103 is disengaged from notch 106 and thus allows door hasp 900 to be moved, and thus allowing the opening of door 700. Lock status alarm 200, if provided, uses a magnet 105 to detect the position of door hasp 900 in reference to door hasp lock mechanism 103. Magnet 105 is used by over-lock control unit 400 to monitor the position of door hasp 900 and to emit an alarm. It will be obvious that other methods to detect the position of door hasp 900 could be used, such as hall-effect sensors. Lock status indicator 300 is mounted on the outside of storage unit 10 and contains indicators such as Light Emitting Diodes (LEDs), lamps or other devices to indicate whether door 700 is open or closed. Lock status indicator 300 interfaces with over-lock control unit 400 to provide real-time status display of over-lock 100 positioning.

Computer 600 can access database 500 of units, authorized users and their accounts to determine if storage units 10 are rented or not and, if rented, whether the account is delinquent or not. If (1) storage unit 10 is not rented OR (2)(a) storage unit is rented AND (b) the account associated with that unit is delinquent, over-lock 100 is locked, otherwise it is unlocked.

Computer 600 may be directly connected to the database 500 or may be remotely located and communicate to the database 500 via various methods (wireless, internet, etc.) When a tenant's account becomes delinquent, the computer 600, will update the database 500 and send a signal to over-lock control unit 400. Over-lock control unit 400 then engages over-lock 100 preventing door hasp 900 from being moved. Preventing movement of door hasp 900 prevents the tenant from having access to self-storage unit 10.

When a tenant makes a payment and brings a delinquent account current, computer 600, will update database 500 and send a signal to over-lock control unit 400. Over-lock control unit 400 disengages over-lock 100 allowing door hasp 900 to be moved. Movement of door hasp 900 allows the tenant access to self-storage unit 10.

When self-storage unit 10 becomes vacant, computer 600 updates database 600 and simultaneously sends a signal to over-lock control unit 400. Over-lock control unit 400 then engages over-lock 100 preventing door hasp 900 from being moved and preventing self-storage unit 10 from being accessed. If storage unit 10 is rented to a new tenant then the computer 600, will update database 500 and sends a signal to over-lock unit 400, which disengages over-lock 100 and allows door hasp 900 to be moved for access to the self-storage unit.

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

1. An over-lock system for use with a self-storage unit, said over-lock system comprising:
a storage unit having a hasp that moves between a locked position and an unlocked position, said storage unit being locked when said hasp is in said locked position and being unlocked when said hasp is in said unlocked position;
a computer having a database containing information regarding said storage unit and an account corresponding to said storage unit, said computer being adapted to send a first signal;
an over-lock control unit responsive to said first signal from said computer and adapted to provide a second signal;
an over-lock mounted to said storage unit and adapted to receive said second signal and permit or prevent said hasp of said storage unit from moving in accordance with said second signal received, said computer accessing said information from said database to determine whether said storage unit has been rented and, if rented, the status of said account, said computer sending a first signal to lock said over-lock control unit if either said storage unit is not rented or if said account corresponding to said storage unit is delinquent, and said computer sending said first signal to said over-lock control unit to unlock said storage unit if said account corresponding to said storage unit is current.

2. The over-lock system as recited in claim 1, wherein said over-lock further comprises:
an actuator;
a linkage connected to said actuator; and
a door hasp lock having a slot formed therein and dimensioned to receive said hasp, and wherein said hasp has a notch formed therein and said actuator has a locking position and an unlocking position, and wherein when said actuator moves said linkage and said door hasp lock from said unlocking position to said locking position, said door hasp lock moves into said notch, thereby preventing said hasp from moving through said slot of said door hasp lock.

3. The over-lock system as recited in claim 1, further comprising means for detecting the position of said hasp.

4. The over-lock system as recited in claim 3, further comprising a display indicating the position of said hasp and the status of said over-lock

5. An over-lock system for use with a self-storage unit, said over-lock system comprising:
a storage unit having a lock that has a locked position and an unlocked position, said storage unit being locked when said lock is locked and being unlocked when said lock is unlocked;
an over-lock mounted to said storage unit, said over-lock having a locked position and an unlocked position, and wherein said storage unit is locked when said over-lock is in said locked position and is unlocked when said over-lock is in said unlocked position, said over-lock, when in said locked position, preventing said storage unit from being accessed; and
means for switching said over-lock between said locked and said unlocked position.

6. The over-lock system as recited in claim 5, wherein said switching means automatically switches said over-lock to said locked position when said storage unit is not rented.

7. The over-lock system as recited in claim 5, wherein said switching means automatically switches said over-lock to said unlocked position when said storage unit is rented.

8. The over-lock system as recited in claim 5, wherein said storage unit corresponds to an account and wherein said switching means automatically switches said over-lock to said locked position when said account is delinquent.

9. The over-lock system as recited in claim 5, wherein said storage unit corresponds to an account and wherein said switching means automatically switches said over-lock to said unlocked position when said account is current.

10. The over-lock system as recited in claim 5, further comprising:
a computer having a database; and
a computer interface adapted to allow a user to create an account that corresponds to a storage unit.

11. The over-lock system as recited in claim 5, wherein said storage unit corresponds to an account, and wherein said over-lock system further comprises:
a computer having a database; and
a computer interface adapted to allow a user to pay into said account.

12. The over-lock system as recited in claim 5, further comprising means for displaying information with respect to said storage unit, said information including the position of said over-lock.

13. The over-lock system as recited in claim 5, wherein said over-lock, when in said locked position, preventing said lock from being in said unlocked position.

14. The over-lock system as recited in claim 5, wherein said switching means wirelessly switches said over-locked between said locked position and said unlocked position.

15. The over-lock system as recited in claim 5, wherein said switching means remotely switches said over-lock between said locked position and said unlocked position.
